(19) United States
(12) Patent Application Publication
(10) Pub. No.: US 2026/0164155 A1
(43) Pub. Date: Jun. 11, 2026

(54) TRASH CAN OR PLANTER POT ASSEMBLY WITH INTEGRATED SPEAKER AND ILLUMINATION DEVICE

(71) Applicant: JME & Co. NYC, LLC, New York, NY (US)

(72) Inventors: Jack SCABA, New York, NY (US); So KONDO, Astoria, NY (US)

(21) Appl. No.: 18/974,153

(22) Filed: Dec. 9, 2024

(51) Int. Cl. H04R 1/02; B65D 25/20; B65F 1/14

(52) U.S. Cl. CPC H04R 1/028; B65D 25/20; B65F 1/1426; B65F 2210/139

(57) ABSTRACT

An apparatus includes a trash can or planter pot unit including a bottom wall and one or more surrounding sidewalls that define an interior receiving space. A speaker assembly is removably attached to the trash can or planter pot unit and acting as a base on which the trash can or planter pot unit sits during use. In implementations, the bottom wall includes a downwardly extending first tubular connection part and the speaker assembly includes a second tubular connection part that engages with the first tubular connection part for holding the speaker assembly to the trash can or planter pot unit.

### TECHNICAL FIELD

This application relates generally to trash cans and planter pots and, more specifically, to a trash can or planter pot assembly with an integrated speaker unit.

### BACKGROUND

The prevalence of the use of wireless speakers (e.g., using Bluetooth® technology) in society is ever expanding. People continue to have an increasing desire for access to music, podcasts and other audio content. This is particularly evident in younger generations.

It would be desirable to provide a new speaker device that is also usable for utility purposes, particularly in environments where space is limited, such as college dorm rooms.

### SUMMARY

In one aspect, an apparatus includes a trash can or planter pot unit including a bottom wall and one or more surrounding sidewalls that define an interior receiving space. A speaker assembly is removably attached to the trash can or planter pot unit and acting as a base on which the trash can or planter pot unit sits during use.

In implementations, the bottom wall includes a downwardly extending first tubular connection part and the speaker assembly includes a second tubular connection part that engages with the first tubular connection part for holding the speaker assembly to the trash can or planter pot unit.

In implementations, the second tubular connection part threadedly engages with the first tubular connection part.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1-2 are perspective views of a trash can and speaker assembly;

FIGS. 3-4 show perspective views of portions of the trash can and speaker assembly;

FIGS. 5-6 show perspective views depicting the speaker assembly separated from the trash can unit;

FIGS. 7-8 show interconnecting features of the trash can unit and the speaker assembly;

FIG. 9 shows a fully-exploded view of the trash can and speaker assembly;

FIG. 10 shows a perspective view of a bottom housing portion of the speaker assembly;

FIGS. 11-12 show cross-sectional views of portions of the trash can and speaker assembly; and

FIG. 13 shows an elevation view of a planter pot and speaker assembly.

### DETAILED DESCRIPTION

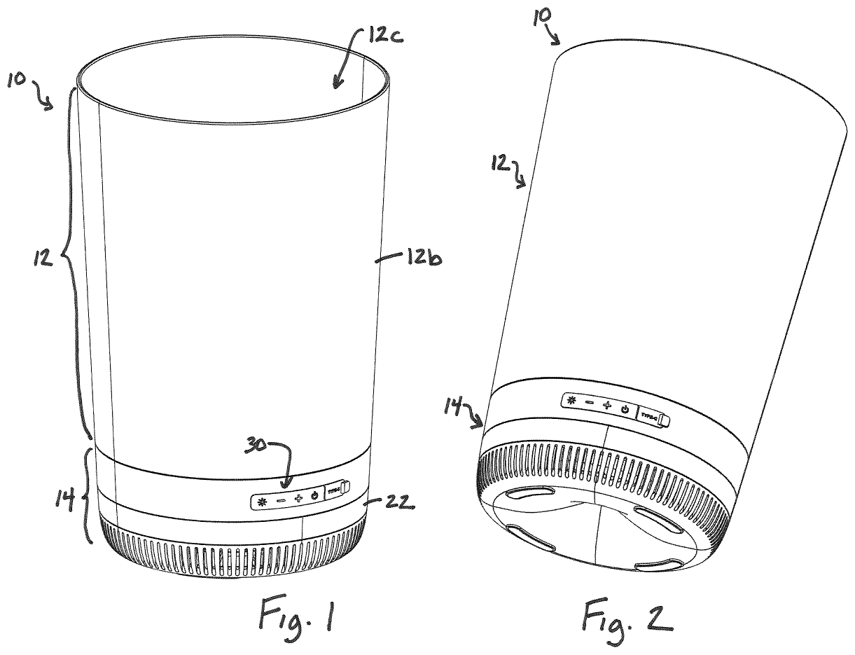

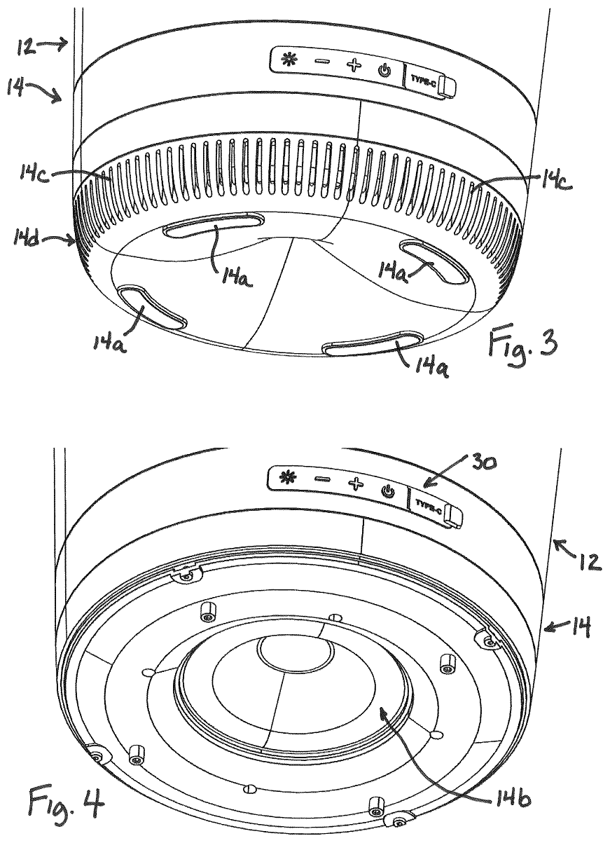

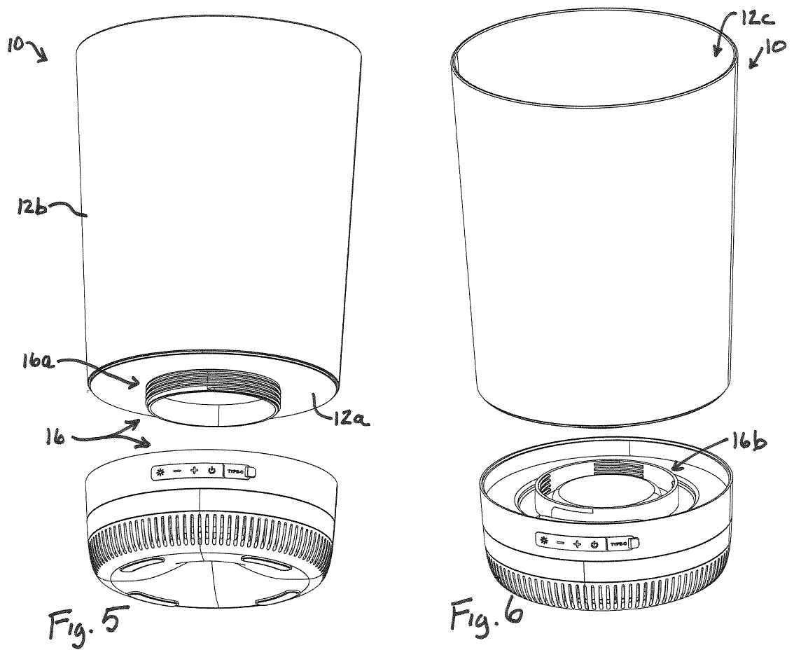

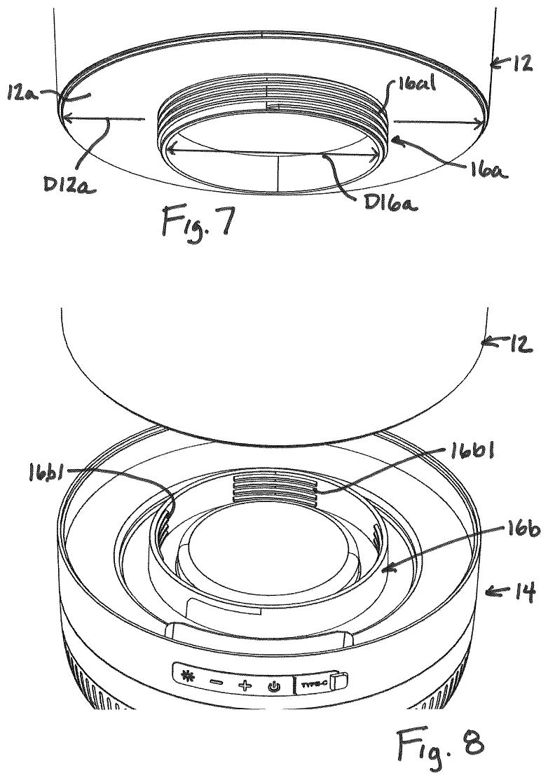

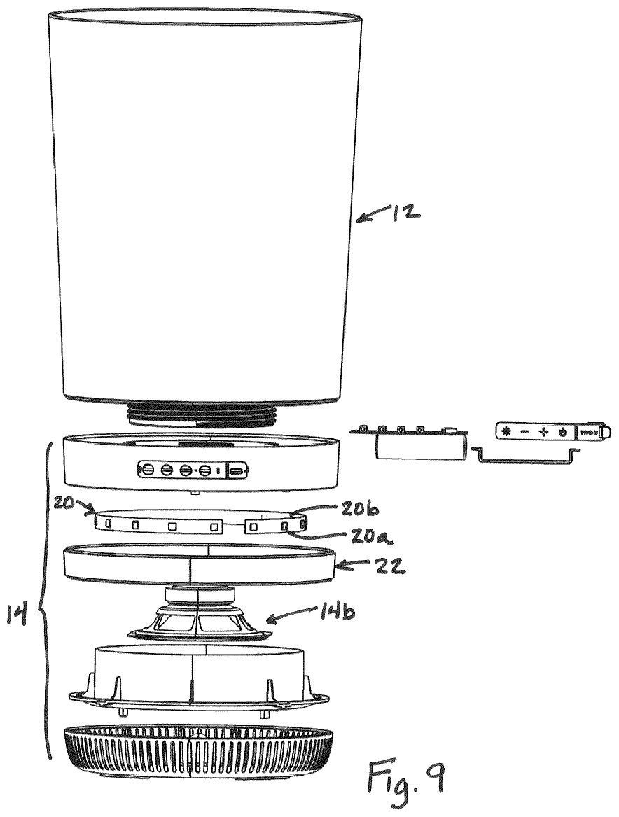

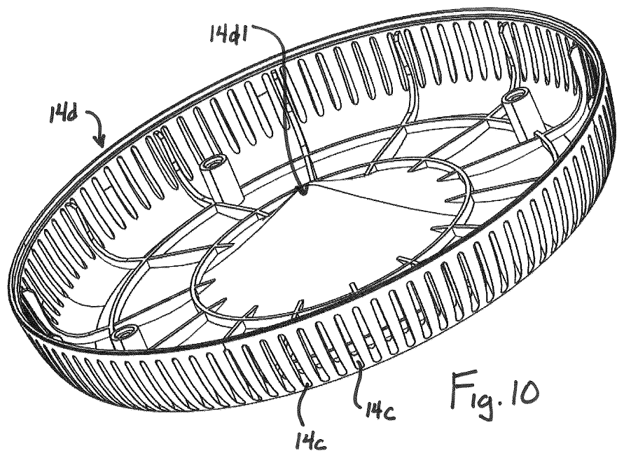

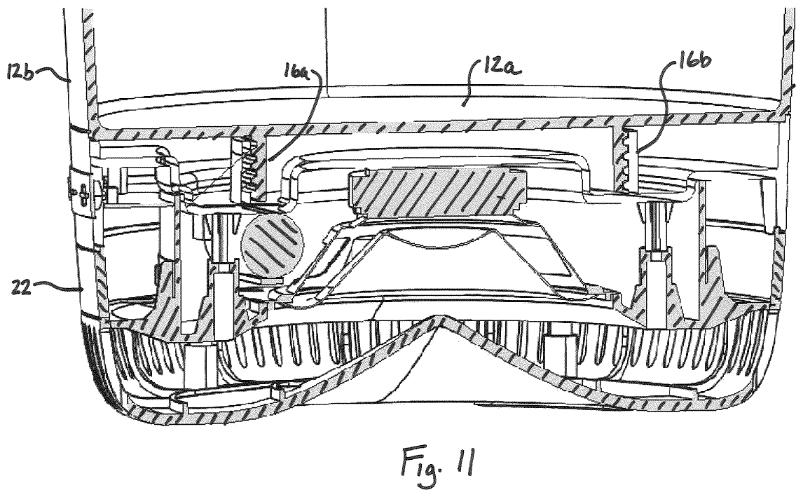

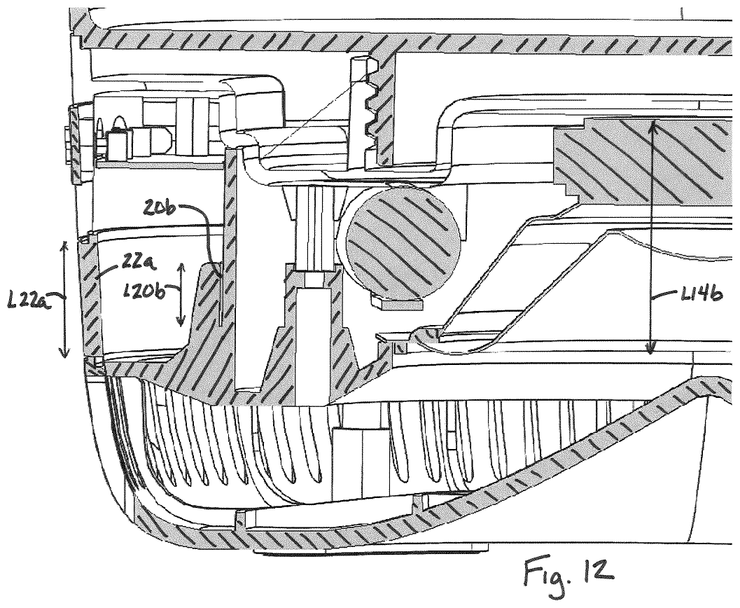

Referring to FIGS. 1-12, a trash can and speaker assembly 10 includes a trash can unit 12 and a speaker assembly 14. The trash can unit includes a bottom wall 12a and one or more surrounding sidewalls 12b that define an interior space 12c for receiving trash. The speaker assembly 14 is removably attached to the trash can unit 12 and acts as a base on which the trash can unit 10 sits during use. The bottom of the speaker assembly 14 includes a plurality of downwardly extending support feet 14a for this purpose. Here, the trash can unit 12 includes a continuous tubular sidewall 12b that defines a slight outward taper extending upward from the bottom wall 12a, but embodiments in which the sidewall(s) 12b define a cylindrical shape, such as a right-circular cylinder, are also possible. Notably, the bottom wall 12a and sidewall 12b operate to seal the bottom of the interior space 12c to avoid any contamination of the speaker assembly 14 by material placed into the interior space.

The speaker assembly 14 and the trash can unit 12 collectively define a rotational inter-engagement system 16 by which the speaker assembly 14 is rotationally secured to the trash can unit 12 and rotationally removable from the trash can unit 12. Here, to form the inter-engagement system 16, the bottom wall 12a includes a downwardly extending tubular connection part 16a and the speaker assembly 14 includes an upwardly extending tubular connection part 16b that engages with the tubular connection part 16a for holding the speaker assembly 14 to the trash can unit 12.

In the illustrated embodiment, the tubular connection part 16b threadedly engages with the tubular connection part 16a. For this purpose, the tubular connection part 16a is externally threaded, and the tubular connection part 16b is internally threaded, such that the tubular connection part 16a is threaded into the tubular connection part 16b to make the connection. However, in an alternative embodiment, the tubular connection part 16a could be internally threaded and the tubular connection part 16b could be externally threaded. The threads 16a1 of the tubular connection part 16a are shown as continuously running helical threads, but could be discontinuous or intermittent. The threads 16b1 of the tubular connection part 16b are shown as intermittent, but could be continuous.

The tubular connection part 16a is inset radially inwardly of the perimeter of the bottom wall 12a and radially inwardly of the sidewall 12b of the trash can unit. In the illustrated embodiment, the diameter D16a of the tubular connection part is at least 30% of a diameter D12a of the bottom wall 12a and is less than 80% of the diameter D12a. This provides for stability of the connection between the speaker assembly 14 and the trash can unit 12. By way of example, diameter D16a may be between 40% and 60% of diameter D12a. But other variations are possible. Notably, the

In the illustrated embodiment, the speaker assembly 14 incorporates an internal lighting unit 20 and a least light emitting portion 22 of the speaker assembly 14 is transparent or translucent. Here, the light emitting portion 22 is formed by an annular wall portion of the speaker assembly, where the annular wall portion is disposed at an intermediate location along a height of the speaker assembly 14. The illustrated lighting unit 20 is formed by a series of light-emitting diodes 20a distributed along the outer surface of a band element 20b, but other variations are possible.

The speaker assembly 14 includes an internal downwardly facing speaker 14b and a series of sound emitting slots 14c disposed in a housing portion 14d of the speaker assembly, which slots 14c are located lower than the speaker 14b. Here, the sound emitting slots 14c are elongated in a vertical direction and are equidistantly spaced around the housing portion 14d. The bottom wall of the speaker assembly may be configured for directing sound from the speaker 14b toward the slots 14c, such as by including a central projection 14d1 and smooth tapered curvature toward the slots 14c.

The speaker assembly 14 incorporates a control interface 30 that enable a user to adjust sound level, vary a light emitting scheme, charge an internal battery and/or activate and deactivate the speaker assembly. The speaker assembly utilizes wireless technology enabling connection to mobile devices (e.g., phones) for user entertainment.

Notably, an axial length L14b of the speaker 14b axially overlaps with the axial length L20b of the band element 20b carrying the light-emitting diodes 20a as well as the axial length L22a of the transparent or translucent wall portion 22a that through which the light passes. Moreover, the light-emitting portion 22 of the speaker assembly 14 is located below the control interface 30.

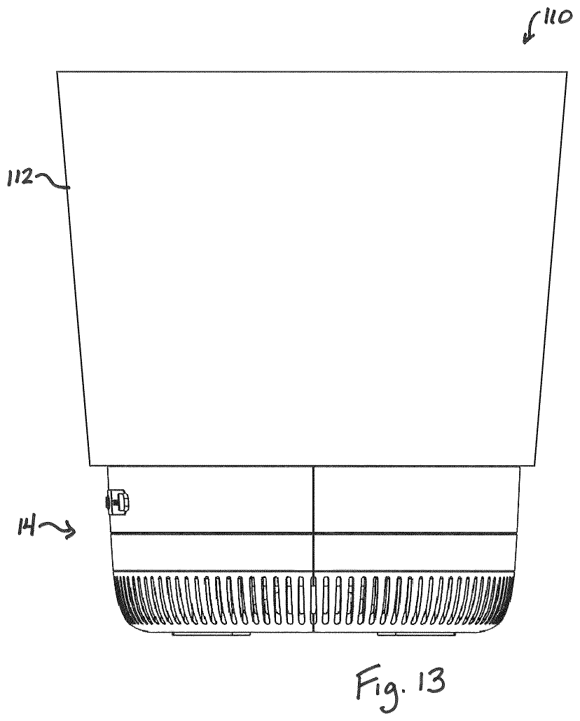

Referring to FIG. 13, a planter pot and speaker assembly 110 is shown and includes a speaker assembly 14 and a planter pot unit 112. The speaker assembly 14 is identical in configuration to that described above, and the planter pot unit 112 includes the same connection features as that of the trash can unit 12.

It is to be clearly understood that the above description is intended by way of illustration and example only, is not intended to be taken by way of limitation, and that other changes and modifications are possible.

1. An apparatus, comprising:
a trash can or planter pot unit including a bottom wall and one or more surrounding sidewalls that define an interior receiving space;
a speaker assembly removably attached to the trash can or planter pot unit and acting as a base on which the trash can or planter pot unit sits during use.

2. The apparatus of claim 1, wherein the bottom wall includes a downwardly extending first tubular connection part and the speaker assembly includes a second tubular connection part that engages with the first tubular connection part for holding the speaker assembly to the trash can or planter pot unit.

3. The apparatus of claim 2, wherein the first tubular connection part is spaced radially inwardly of a perimeter of the bottom wall.

4. The apparatus of claim 2, wherein the second tubular connection part threadedly engages with the first tubular connection part.

5. The apparatus of claim 4, wherein the first tubular connection part is externally threaded, the second tubular connection part is internally threaded, and the first tubular connection part is threaded into the second tubular connection part.

6. The apparatus of claim 2, wherein a diameter of the first tubular connection part is between 40% and 60% of a diameter of the bottom wall.

7. The apparatus of claim 1, wherein the speaker assembly and the trash can or planter pot unit collectively define a rotational inter-engagement system by which the speaker assembly is rotationally secured to the trash can or planter pot unit and rotationally removable from the trash can or planter pot unit.

8. The apparatus of claim 1, wherein the speaker assembly incorporates an internal lighting unit and at least a light emitting portion of the speaker assembly is transparent or translucent.

9. The apparatus of claim 8, wherein the light emitting portion is formed by an annular housing wall portion of the speaker assembly.

10. The apparatus of claim 9, wherein the speaker assembly includes an internal speaker component, wherein an axial height of the internal speaker component axially overlaps with an axial height of the annular housing wall portion.

11. The apparatus of claim 1, wherein a bottom of the speaker assembly includes a plurality of downwardly extending support feet.

12. The apparatus of claim 1, wherein the speaker assembly includes an internal downwardly facing speaker and a series of sound emitting slots disposed in a housing portion of the speaker assembly and located lower than the speaker.

13. The apparatus of claim 12, wherein the sound emitting slots are elongated in a vertical direction and are equidistantly spaced around the housing portion.
